(19) United States
(12) Patent Application Publication
(10) Pub. No.: US 2026/0109066 A1
(43) Pub. Date: Apr. 23, 2026

(54) CUTTING ROLLER FOR INTERFOLDING MACHINE

(71) Applicant: OT LUCCA S.R.L., MONTECARLO (LU) (IT)

(72) Inventors: Massimo PARENZI, VIAREGGIO (LU) (IT); Valter CECCARELLI, CHIESINA UZZANESE (PT) (IT)

(73) Assignee: OT LUCCA S.R.L., MONTECARLO (LU) (IT)

(21) Appl. No.: 19/116,368

(22) PCT Filed: Sep. 27, 2023
(86) PCT No.: PCT/IB2023/059601

§ 371 Date: Mar. 28, 2025

(30) Foreign Application Priority Data
Sep. 28, 2022 (IT) 102022000019896

(51) Int. Cl. B26D 1/38; B26D 7/26; B65H 35/08; B65H 45/24

(52) U.S. Cl. CPC B26D 1/385; B26D 7/2614; B65H 35/08; B65H 45/24

(57) ABSTRACT

A cutting roller includes a main body activatable in rotation and including a first seat; an insert arranged to insert in the first seat, borne by the main body and including a first through-hole; a blade arranged between the main body and the insert; the main body includes a second seat; a pressing element borne by the insert and interposed between the insert and the main body; support means connected to the insert and arranged to support the pressing element; fixing means positioned to cross the first through-hole and received in the second seat to fix the main body and the insert. Once the fixing means are positioned and the main body and the insert are fixed, the pressing element exerts a pressing force on the blade so that the main body and the insert maintain the blade in position defining a first abutment area and a second abutment area.

### FIELD OF THE INVENTION

The present invention relates to the technical sector concerning transformation of paper for production of paper material in packs of interfolded sheets. In particular, the present invention relates to a cutting roller for an interfolding machine.

In general terms, an interfolding machine can be provided with a cutting roller having a plurality of blades arranged and configured to cut a paper strip, infeeding to the interfolding machine, into a plurality of strips or sheets of paper that will successively be folded and interfolded with respect to one another to realise packs of strips or sheets of paper.

In detail, the cutting operation takes place by means of the blades in contact with a counter-blade borne by a fixed longitudinal element: in fact, during the drawing of the paper strip, when a blade and the counter-blade are arranged with cutting profiles thereof in contact, the cutting of the paper strip takes place.

The blades and the counter-blade have a length that is equal to the width of the paper strip, so that the strip is cut through the whole width thereof.

### DESCRIPTION OF THE PRIOR ART

A known cutting roller (100) for an interfolding machine comprises: a main body (101) which is activatable in rotation with respect to the axis thereof; at least a blade (102) which is borne by the main body (101); a blade block insert (103) which is borne by the main body (101) and which is arranged in such a way as to have a first portion (104) which is in contact, at least partially, with the at least a blade (102), and a second portion (105) which is in at least partial contact with the main body (101); fixing means (106) which are arranged so as to fix the blade block insert (102) and the main body (101) to one another. The fixing means (106) comprise a screw (107) and a hole (108) which crosses the blade block insert (103) and, at least partially, the main body (101), and which is conformed so as to receive the screw (107). In detail, when the screw (107) is inserted in the hole (108) to fix the blade block insert (103) and the main body (101) to one another, the screwing-in determines a relative movement of the blade block insert (103), i.e. a rotation of the blade block insert (103) towards the at least a blade (102), with respect to the second portion (105) which contacts the main body (101), so that the first portion (104) can contact the at least a blade (102) and the blade (102) is maintained in a predetermined position, between the blade block insert (103) and the main body (101), during the activation in rotation of the cutting roller (100).

However, it has been found that the above-mentioned contact between the blade block insert (103) and the at least a blade (102) is such that the blade block insert (103) exerts a pressing force on the at least a blade (102) which is not uniform along the entire relative contact area between them.

Following the screwing-in of the screw (107) into the hole (108), the blade block insert (103) will rotate with respect to the second portion (105), i.e. a first abutment area (R1) between the blade block insert (103) and the main body (101), and will contact the at least a blade (102) at a second and third abutment area (R2, R3) which will define a plane that is such as not to be parallel to the plane defined by the at least a blade (102).

This leads to flexion events of the at least a blade (102) during the activation in rotation of the main body (101) and, therefore, during the cutting operation: in fact, a consequence is a lack of precision and cleanness of the cut to be made, as well as an erroneous positioning of the cut to be made along the paper strip.

In other words, the portion of the cutting roller (100) involved by the blade block insert (103) will have three abutment areas (R1, R2, R3) between the blade block insert (103) and the main body (101). In this way, the flexion of the at least a blade (102), during the activation in rotation of the main body (101), is justified by the fact that this portion will behave as a hyperstatic system and therefore, with a number of degrees of constraints greater than the number of degrees of freedom: in fact, in this way the static nature of the structure is absent, as it will be shown still to be movable.

### SUMMARY OF THE INVENTION

In the light of the above, the aim of the present invention consists in obviating the above-mentioned drawback.

The above is attained by a cutting roller for an interfolding machine according to claim 1 or claim 7.

The cutting roller for an interfolding machine, object of the present inventions, is advantageously configured in such a way as to have a first abutment area and a second abutment area between the main body and the insert.

In this way, the portion of the cutting roller affected by the insert and the blade will behave in the way of an isostatic system and will guarantee the static condition of the structure, limiting the possibility of movement of the blade, interposed between the main body and the insert, during use.

According to the first invention or the second invention, the fixing means, for fixing the main body and the insert to one another, will ensure a pressing force, given by the insert on the first end portion of the blade, uniform along the part of blade affected which, in the case of the first invention will be exerted by the pressing element, while in the case of the second invention will be exerted by the insert.

In other words, once the fixing means for fixing the main body and the insert to one another have been arranged, the insert will exert: in the case of the first invention, a pressing force on the blade and on the main body, which will define a first abutment area and a second abutment area between the main body and the insert; and in the case of the second invention, a pressing force on the blade, which will define a first abutment area and a second abutment area between the main body and the insert.

It follows that in this way the obtaining of a cutting roller which will carry out cutting operations that are precise and clean, optimising the quality of the final product, and reducing the risk of a machine halt for the removal of the paper which might have adhered to the surface of the blade.

### BRIEF DESCRIPTION OF THE DRAWINGS

Specific embodiments of the invention will be described in the following part of the present description, according to what is set down in the claims and with the aid of the accompanying tables of drawings, in which:

FIG. 1 is a view of a known cutting roller for an interfolding machine;

FIG. 2 is a view of the cutting roller, according to the first invention, when arranged flanked to a fixed longitudinal element which bears the counter-blade;

FIG. 3 is a lateral view of the cutting roller of FIG. 2, of which a portion has been illustrated semi-exploded;

FIG. 4 is a lateral view of the cutting roller of FIG. 2;

FIGS. 4A and 4B are views in transversal section of FIG. 4, taken according to two different sections;

FIG. 5 is a view of the cutting roller, according to the second invention, when flanked to a fixed longitudinal element which bears the counter-blade;

FIG. 6 is a lateral view of the cutting roller of FIG. 5, of which a portion has been illustrated semi-exploded;

FIG. 7 is a lateral view of the cutting roller of FIG. 5;

FIG. 7A is a view in transversal section of FIG. 7;

FIG. 7B is an exploded view of FIG. 7A;

FIG. 8 is a view of detail K of FIG. 4;

FIG. 9 is a view of detail W of FIG. 7;

FIG. 10 and FIG. 11 are views of the blade, according to the second invention.

### DESCRIPTION OF THE PREFERRED EMBODIMENTS

With reference to the appended tables of drawings, reference numeral (1) denotes in its entirety a cutting roller for an interfolding machine, object of the present invention.

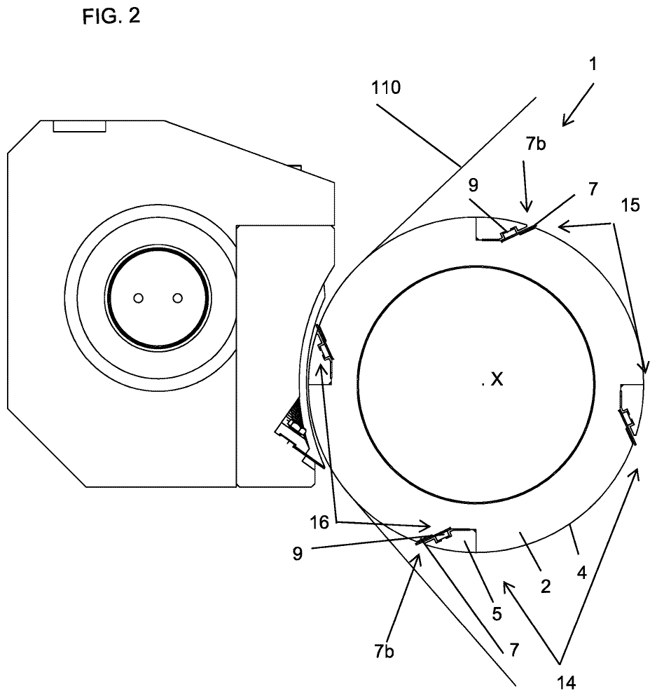

According to the first invention, the cutting roller (1) comprises: a main body (2) which is activatable in rotation with respect to the axis thereof (X) and which comprises a first seat (3) defined by a missing portion fashioned on the relative outer lateral surface (4); an insert (5) which is arranged so as to insert in the first seat (3), which is borne by the main body (2) and which comprises a first through-hole (6) which places the main body (2) in communication with the outside environment, when the insert (5) is inserted in the first seat (3); a blade (7) which is arranged interposed between the main body (2) and the insert (5), which comprises a first end portion (7a) and a second end portion (7b) which are opposite one another. Further, the main body (2) comprises a second seat (8). Further, the cutting roller (1) comprises: a pressing element (9) which is borne by the insert (5) and which is interposed between the insert (5) and the main body (2); support means (10) which are connected to the insert (5) and which are arranged so as to support the pressing element (9) in such a way that it contacts the first end portion (7a) of the blade (7) during use; the first through-hole (6) and the second seat (8) are arranged in such a way as to be aligned to one another, when the insert (5) is received in the first seat (3); fixing means (11) which are positioned so as to cross the first through-hole (6) and to be received in the second seat (8) in such a way as to fix the main body (2) and the insert (5) to one another. The fixing means (11), the pressing element (9), the insert (5) and the main body (2) are configured in such a way that, during use, once the fixing means (11) have been positioned and the main body (2) and the insert (5) have been fixed to one another, the pressing element (9) exerts a pressing force on the blade (7) so that the main body (2) and the insert (5) maintain the blade (7) in position, defining a first abutment area (Z1) and a second abutment area (Z2) between them (see FIGS. 2-4).

In detail, following the positioning of the fixing means (11), in order to fix the main body (2) and the insert (5) to one another, the pressing element (9) exerts a pressing force on the blade (7), at the first abutment area (Z1); while the insert (5) exerts a further pressing force on the main body (2), at the second abutment area (Z2).

The fixing means (11) and the support means (10) are preferably distinct from one another.

The support of the pressing element (9) and the fixing between the main body (2) and the insert (5) advantageously occurs by distinct means so that it is possible to intervene on one or the other independently.

In other words, it is possible to intervene on the support means (10) in order to regulate the pressure on the pressing element (9) on the blade (7), without interfering with the pressure that the insert (5) exerts on the main body (2).

The first abutment area (Z1) is preferably identified in the contact area between the pressing element (9) and the blade (7) and the second abutment area (Z2) is identified in the contact area between the insert (5) and the main body (2).

Once the fixing means (11) for fixing the main body (2) and the insert (5) to one another are arranged, the insert (5) will advantageously exert a pressing force, via the direct contact on the main body (2), and the pressing element (9) will exert a pressing force, via the direct contact, on the blade (7).

Therefore, the pressing element (9) and the blade (7) can be in mutual contact only at the first abutment area (Z1); the insert (5) and the main body (2) can be in mutual contact only at the second abutment area (Z2).

It follows that, during use, the main body (2) and the insert (5) maintain the blade (7) in position between them.

The pressing element (9) is preferably borne by the insert (5) in such a way as to be interposed between the insert (5) and the blade (7), at the first abutment area (Z1).

The support means (10) advantageously support the pressing element (9) so as to exert a pressing force on the blade (7) such as to maintain the blade (7) in position between the main body (2) and the insert (5), during use of the cutting roller (1).

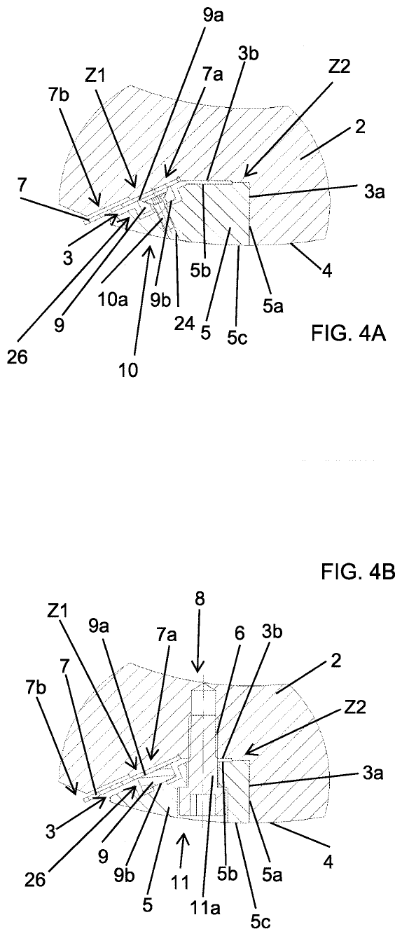

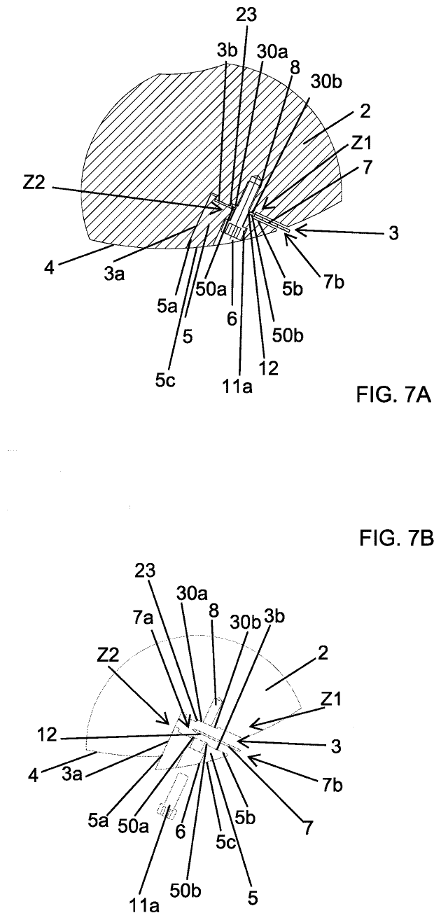

The fixing means (11) can comprise a screw (11a) and the support means (10) can comprise a second screw (10a) which bears the pressing element (9) (see FIGS. 4B and 7A).

According to this embodiment of the invention, the insert (5) can comprise a second hole (24) conformed to receive the second screw (10a).

In detail, the pressing element (9) is fixed by the insert (5) by means of the second screw (10a), so that it is maintained in a position such as to contact the first end portion (7a) of the blade (7) during use.

The insert (5) can comprise a housing (26).

The housing (26) can be conformed to receive the pressing element (9) in such a way that it contacts the first end portion (7a) of the blade (7).

The pressing element (9) can have a portion conformed to receive the head of the second screw (10a) which is arranged at the second hole (24).

By way of example, the second screw (10a) can be a countersunk screw.

With reference to FIGS. 4A and 4B, the second screw (10a) crosses the second hole (24), when the insert (5) is received in the first seat (3). According to the first invention, the insert (5) can comprise a second plurality of through-holes (25) which comprise the second hole (24).

According to the second invention, the cutting roller (1) comprises: a main body (2) which is activatable in rotation with respect to the axis thereof (X) and which comprises a first seat (3) defined by a missing portion fashioned on the relative outer lateral surface (4); an insert (5) which is arranged so as to insert in the first seat (3), which is borne by the main body (2) and which comprises a first through-hole (6) which places the main body (2) in communication with the outside environment, when the insert (5) is inserted in the first seat (3); a blade (7) which is arranged interposed between the main body (2) and the insert (5), which comprises a first end portion (7a) and a second end portion (7b) which are opposite one another and which comprises a through-opening (12) made on the first end portion (7a). Further, the main body (2) comprises a second seat (8) and the first through-hole (6), the through-opening (12) and the second seat (8) are arranged in such a way as to be aligned to one another when the insert (5) is received in the first seat (3). Further, the cutting roller (1) comprises fixing means (11) which are positioned so as to cross the first through-hole (6) and the through-opening (12), so as to be received in the second seat (8) in order to fix the main body (2) and the insert (5) to one another.

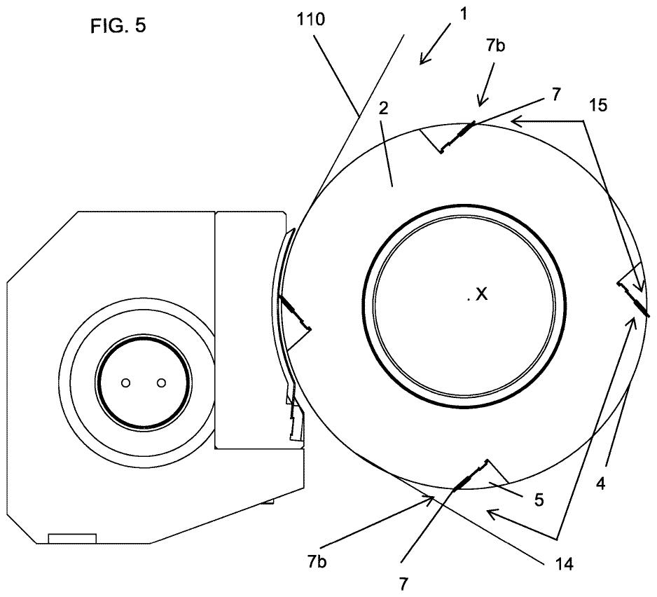

The fixing means (11), the insert (5) and the main body (2) are configured in such a way that, during use, once the fixing means (11) have been positioned and the main body (2) and the insert (5) fixed to one another, the insert (5) and the main body (2) maintain the blade (7) in position defining a first abutment area (Z1) and a second abutment area (Z2) between them (see FIGS. 5-7).

In detail, following the positioning of the fixing means (11), in order to fix the main body (2) and the insert (5) to one another, the insert (5) exerts a pressing force on the blade (7), at the first abutment area (Z1) and the second abutment area (Z2).

It follows that, during use, the main body (2) and the insert (5) maintain the blade (7) in position between them.

In other words, for both the first invention and the second invention, the main body (2) and the insert (5) can maintain the blade (7) in position defining only the first abutment area (Z1) and the second abutment area (Z2) between one another.

In accordance with the second invention, the first abutment area (Z1) can be identified in the first contact area between the insert (5) and the blade (7).

Further, the second abutment area (Z2), again according to the second invention, can be identified in the second contact area between the insert (5) and the blade (7).

Therefore, the insert (5) and the blade (7) can be in mutual contact only at the first abutment area (Z1) and the second abutment area (Z2).

According to the above-described embodiment of the second invention, the first seat (3) can comprise a first wall (3a) and a second wall (3b) arranged at an angle to one another; the second wall (3b) can comprise a first abutment portion (30a) and a second abutment portion (30b) which are arranged opposite one another; the insert (5) can comprise: a third wall (5a) which is arranged to abut the first wall (3a); a fourth wall (5b) which is arranged to face the second wall (3b); a fifth wall (5c) which connects the third wall (5a) and the fourth wall (5b) to one another; the fourth wall (5b) can comprise a first protrusion (50a) and a second protrusion (50b); the fixing means (11) are arranged and configured in such a way that, during use, the first abutment portion (30a) and the first protrusion (50a) and the second abutment portion (30b) and the second protrusion (50b) clamp between them a part of the first end portion (7a) of the blade (7).

The first abutment portion (30a) and the first protrusion (50a) on one side and the second abutment portion (30b) and the second protrusion (50b) on the other side, advantageously laterally contain the fixing means (11) at the through-opening (12).

In detail, the blade (7) is maintained in position between the first abutment portion (30a) and the first protrusion (50a) and between the second abutment portion (30b) and the second protrusion (50b).

In other words, a part of the first end portion (7a) of the blade (7) is in contact with the first abutment portion (30a) and the first protrusion (50a) and another part of the first end portion (7a) is in contact with the second abutment portion (30b) and the second protrusion (50b) (see FIG. 7A).

The insert (5) and the blade (7) can be in contact with one another via the first protrusion (50a) and the second protrusion (50b) (see FIG. 7A).

The main body (2) and the blade (7) can be in contact with one another by means of the first abutment portion (30a) and the second abutment portion (30b) (see FIG. 7A).

Again according to the second invention, the first through-hole (6) can be arranged to cross the fourth wall (5b) and the fifth wall (5c) (see FIG. 7B).

The first protrusion (50a) and the second protrusion (50b) can be arranged opposite one another with respect to the first through-hole (6) (see FIG. 7B).

The fifth wall (5c) can complete the outer lateral surface (4) of the main body (2) (see FIG. 7A).

The blade (7) can be arranged interposed between the fourth wall (5b) of the insert and the second wall (3b) of the first seat (3).

The first abutment portion (30a) and the second abutment portion (30b) can be arranged opposite one another with respect to the second seat (8) (see FIG. 7B).

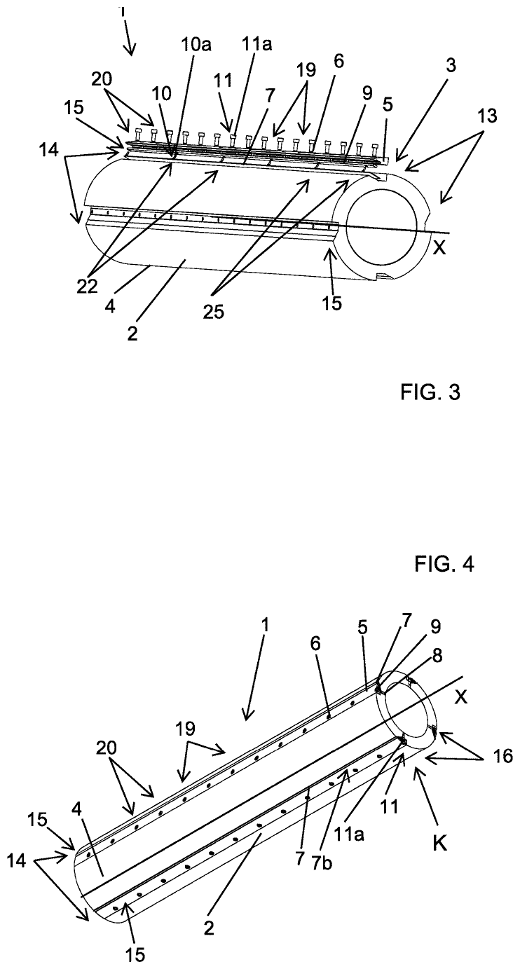

The main body (2) can be cylindrical. In this case, the rotation axis is defined by the height of the cylinder (see FIGS. 3, 4, 6 and 7).

The main body (2) can be a tubular element (see FIGS. 3, 4, 6 and 7).

The main body (2) can have a longitudinal extension (see FIGS. 3, 4, 6 and 7).

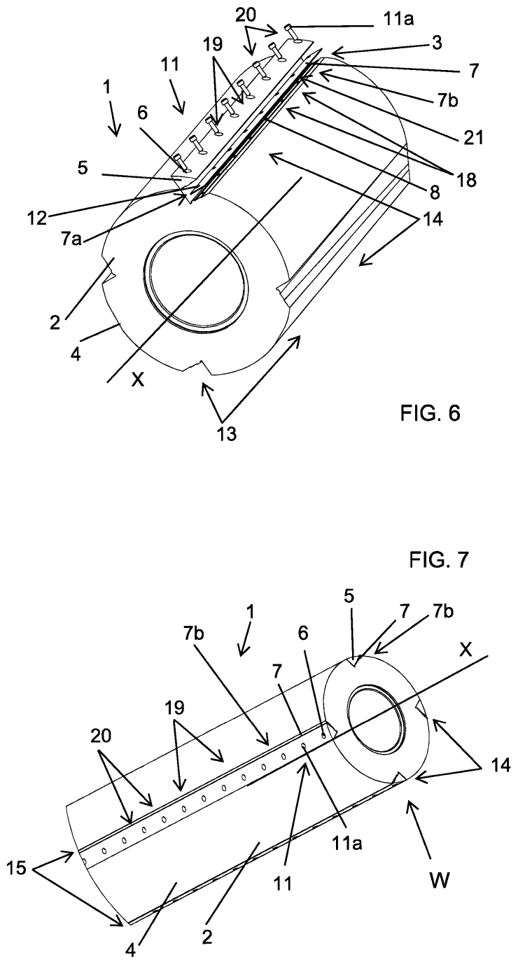

The first seat (3) can extend along the entire length of the main body (2) (see FIGS. 3 and 6).

In other words, the first seat (3) can have a longitudinal extension (see FIGS. 3 and 6).

The outer lateral surface (4) can be a cylindrical surface.

The insert (5) can form the missing portion of the main body (2).

The insert (5) and the first seat (3) can define a form coupling with one another.

The insert (5) can have a longitudinal extension (see FIGS. 3, 4, 6 and 7).

The insert (5) can extend along the entire length of the first seat (3) and therefore of the main body (2) (see FIGS. 3, 4, 6 and 7).

The insert (5) can be made in a single body. Alternatively, the insert (5) can form a plurality of portions arranged in the first seat (3), in succession to one another and along the main body (2) (not illustrated).

The blade (7) can have a longitudinal extension (see FIGS. 3 and 6).

The blade (7) can extend along the entire length of the first seat (3) or the main body (2) (see FIGS. 3 and 6).

The blade (7) can be made in a single body. Alternatively, the blade (7) can form a plurality of lengths arranged interposed between the main body (2) and the insert (5), in succession to one another and along the main body (2) (not illustrated).

The pressing element (9) can have a longitudinal extension (see FIG. 3).

The pressing element (9) can extend along the entire length of the first seat (3) and therefore of the main body (2) (see FIGS. 3 and 4).

The pressing element (9) can be made in a single body. Alternatively, the pressing element (9) can form a plurality of portions arranged interposed between the blade (7) and the insert (5), in succession to one another and along the main body (2) (not illustrated).

The through-opening (12) can be arranged on the first end portion (7a), i.e. the end which contacts the main body (2).

The pressing element (9) can comprise a first wall (9a) and a second wall (9b) which are opposite one another (see FIG. 4B).

When the insert (5) is received in the first seat (3), the first wall (9a) can abut the first end portion (7a) of the blade (7); while the second wall (9b) can abut the insert (5) (see FIG. 4B).

In other words, the first wall (9a) exerts the pressing force on the first end portion (7a) of the blade (7), at the first abutment area (Z1) (see FIG. 4B).

The first seat (3) is preferably an undercut fashioned on the outer lateral surface (4) of the main body (2).

The insert (5) advantageously completes the outer lateral surface (4) of the main body (2).

The insert (5) can be conformed in such a way that when inserted in the first seat (3), it defines the missing portion of the main body (2) (see FIGS. 4 and 7).

The second end portion (7b) is preferably the cutting portion of the blade (7) (see FIGS. 8, 9, 10 and 11).

The first end portion (7a), i.e. the non-cutting end, is advantageously the portion having the through-opening (12) or which contacts the pressing element (9).

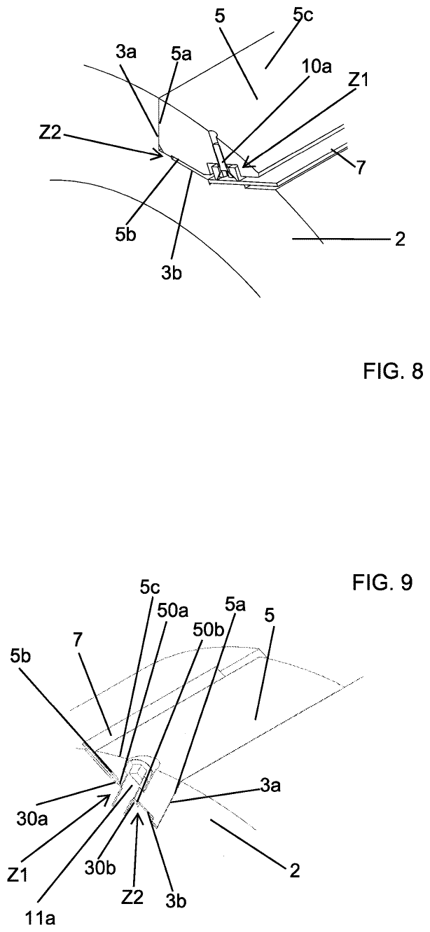

The second end portion (7b) can be at least partially projecting with respect to the main body (2) and to the insert (5) (see FIGS. 8 and 9).

According to the second invention, the extension axis of the screw (11a) can be perpendicular to the plane on which the blade (7) extends, when arranged interposed between the insert (5) and the main body (2) (see FIGS. 7A and 7B).

The first abutment area (Z1) and the second abutment area (Z2), in the first and in the second invention, can be arranged opposite one another with respect to the screw (11a) (see FIGS. 4B and 7A).

In detail, according to the first invention, the screw (11a) is positioned so as to cross the first through-hole (6) and to be received in the second seat (8) (see FIG. 4B).

Again in detail, but according to the second invention, the screw (11a) is positioned so as to cross the first through-hole (6), the through-opening (12), and to be received in the second seat (8) (see FIG. 7A).

According to the first invention, the first seat (3) can comprise the first wall (3a) and a second wall (3b) arranged at an angle to one another and the insert (5) can comprise: the third wall (5a) which is arranged to abut the first wall (3a); the fourth wall (5b) which is arranged to face the second wall (3b); the fifth wall (5c) which connects the third wall (5a) and the fourth wall (5b) to one another (see FIGS. 4A and 4B). Further, with reference to both the first and the second invention, the second seat (8) can extend starting from the second wall (3b) (see FIGS. 4B and 7A).

The second seat (8) can extend towards the inside of the main body (2) starting from the second wall (3b) of the first seat (3) (see FIGS. 4B and 7A).

Again with reference to the first invention, the blade (7) can be arranged interposed between a part of the fourth wall (5b) of the insert (5) and a part of the second wall (3b) of the first seat (3). The remaining part of the fourth wall (5b) of the insert (5) and of the second wall (3b) of the first seat (3) face one another (see FIGS. 4A and 4B).

By way of example, the main body (2) can comprise a plurality of seats (13) and the cutting roller (1) can comprise a plurality of inserts (14) and a plurality of blades (15) (see FIGS. 3, 4, 6 and 7).

For each seat of the plurality of seats (13), each insert of the plurality of inserts (14) and each blade of the plurality of blades (15) the considerations as described in the foregoing for the first seat (3), the insert (5) and the blade (7) are valid.

In detail, with reference to the first invention, the cutting roller (1) can comprise a plurality of pressing elements (16) (see FIGS. 3 and 4).

For each pressing element of the plurality of pressing elements (16), the considerations as described in the foregoing for the pressing element (9) are valid.

In detail, with reference to the second invention, the main body (2) can comprise a plurality of second seats (18) and the insert (5) can comprise a first plurality of through-holes (19) which comprise the first through-hole (6) (see FIG. 3.4, 6 and 7).

According to the second invention, the blade (7) can comprise a plurality of through-openings (21) (see FIGS. 6 and 7).

In the case of the first invention, the fixing means (11) can comprise a plurality of screws (20), each can be screwed to each hole of the first plurality of through-holes (19) in order to be received in each seat of the plurality of second seats (18); while, in the case of the second invention, each screw of the plurality of screws (20) can be screwed to each hole of the first plurality of through-holes (19) in order to be received in each through-opening of the plurality of through-openings (21) and in each seat of the plurality of second seats (18).

With reference to the first invention, the support means (10) can comprise a second plurality of screws (22) (see FIG. 3).

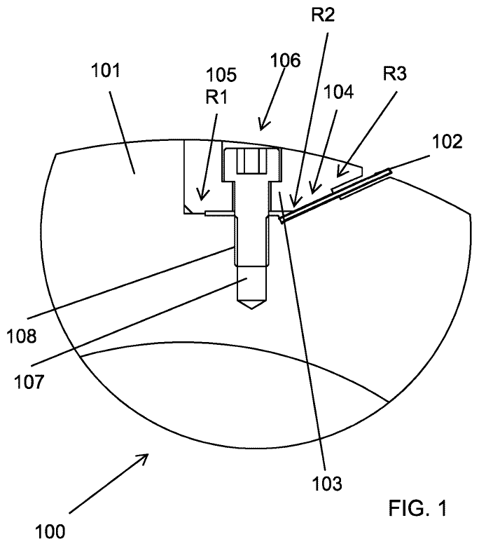

FIG. 1 and FIG. 5 illustrate the cutting roller (1), respectively, according to the first invention and to the second invention, when arranged in proximity of a fixed longitudinal element which bears a counter-blade: in detail, when the blade (7) of the cutting roller (1) and the counter-blade are arranged with the cutting profiles thereof in contact, the cutting of the paper strip (110) takes place.

FIGS. 3 and 4 illustrate the cutting roller (1) according to the first invention, respectively, with the main body (2), the insert (5), the blade (7), the pressing element (9), the support means (10) and the fixing means (11) decoupled from or coupled to one another.

Likewise, FIGS. 6 and 7 illustrate the cutting roller (1) according to the second invention, respectively, with the main body (2), the insert (5), the blade (7) and the fixing means (11) decoupled from or coupled to one another.

FIG. 4A illustrates a part of the cutting roller (1) according to the first invention, in transversal section according to a plane passing through the support means (10).

Instead, FIG. 4B illustrates a part of the cutting roller (1) according to the first invention, in transversal section according to a plane passing through the fixing means (11).

FIG. 7A illustrates a part of the cutting roller (1) according to the second invention, in transversal section according to a plane passing through the fixing means (11).

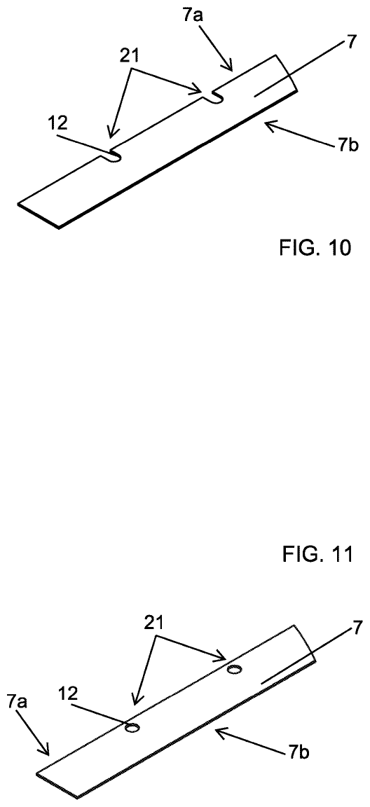

FIG. 10 and FIG. 11 are views of the blade (7), according to the first invention, respectively, when the through-opening (12) forms a slot and when the through-opening (12) forms a through-hole.

With reference to the second invention, the through-opening (12) can form a through-hole.

Alternatively, with reference to the second invention, the through-opening (12) can form a slot.

Advantageously, according to this embodiment, with the purpose of removing the blade (7) it will be sufficient to loosen the fixing means (11) and to slide the blade (7) externalwise of the cutting roller (1).

With reference to FIG. 11, when the blade (7) forms a slot, the main body (2) comprises an abutment wall (23) so that the blade (7) is arranged interposed between the insert (5) and the main body (2) so as to abut, with a relative end, the abutment wall (23).

1. A cutting roller for an interfolding machine comprising:
a main body which is activatable in rotation with respect to an axis thereof and which comprises a first seat defined by a missing portion fashioned on a relative outer lateral surface;
an insert which is arranged so as to insert in the first seat, which is borne by the main body and which comprises a first through-hole which places the main body in communication with the outside environment, when the insert is inserted in the first seat;
a blade which is arranged interposed between the main body and the insert, which comprises a first end portion and a second end portion which are opposite one another;
wherein the main body comprises a second seat;
a pressing element which is borne by the insert and which is interposed between the insert and the main body;
support means which are connected to the insert and which are arranged so as to support the pressing element in such a way that it contacts the first end portion of the blade during use;
wherein the first through-hole and the second seat are arranged in such a way as to be aligned to one another, when the insert is received in the first seat;
fixing means which are positioned so as to cross the first through-hole and to be received in the second seat in such a way as to fix the main body and the insert to one another;
the fixing means, the pressing element, the insert and the main body are configured so that, during use, once the fixing means have been positioned and the main body and the insert fixed to one another, the pressing element exerts a pressing force on the blade so that the main body and the insert maintain the blade in position, defining a first abutment area and a second abutment area between them.

2. The cutting roller for an interfolding machine according to claim 1, wherein the fixing means and the support means are distinct from one another.

3. The cutting roller for an interfolding machine of claim 1, wherein the first abutment area is identified in the contact area between the pressing element and the blade and the second abutment area is identified in the contact area between the insert and the main body.

4. The cutting roller for an interfolding machine of claim 1, wherein the pressing element is borne by the insert in such a way as to be interposed between the insert and the blade, at the first abutment area.

5. The cutting roller for an interfolding machine of claim 1, wherein the fixing means comprise a screw and the support means comprise a second screw which bears the pressing element.

6. The cutting roller of claim 5, wherein the insert comprises a second hole conformed to receive the second screw.

7. A cutting roller for an interfolding machine comprising:
a main body which is activatable in rotation with respect to an axis thereof and which comprises a first seat defined by a missing portion fashioned on a relative outer lateral surface;
an insert which is arranged so as to insert in the first seat, which is borne by the main body and which comprises a first through-hole which places the main body in communication with the outside environment, when the insert is inserted in the first seat;
a blade which is arranged interposed between the main body and the insert, which comprises a first end portion and a second end portion which are opposite one another and which comprises a through-opening made on the first end portion;
wherein the main body comprises a second seat;
the first through-hole, the through-opening and the second seat are arranged in such a way as to be aligned to one another, when the insert is received in the first seat;
fixing means which are positioned so as to cross the first through-hole, the through-opening and to be received in the second seat in such a way as to fix the main body and the insert to one another;
the fixing means, the insert) and the main body are configured in such a way that, during use, once the fixing means have been positioned and the main body and the insert fixed to one another, the insert and the main body maintain the blade in position defining a first abutment area and a second abutment area between one another.

8. The cutting roller of claim 7, wherein: the first seat comprises a first wall and a second wall arranged at an angle to one another; the second wall comprises a first abutment portion and a second abutment portion which are arranged opposite one another; the insert comprises: a third wall which is arranged to abut the first wall; a fourth wall which is arranged to face the second wall; a fifth wall which connects the third wall and the fourth wall to one another; the fourth wall comprises a first protrusion and a second protrusion; the fixing means are arranged and configured in such a way that, during use, the first abutment portion and the first protrusion and the second abutment portion and the second protrusion clamp between them a part of the first end portion of the blade.

9. The cutting roller of claim 7, wherein the through-opening forms a through-hole.

10. The cutting roller of claim 7, wherein the through-opening forms a slot.

11. The cutting roller of claim 7, wherein the first seat is an undercut fashioned on the outer lateral surface of the main body.

12. The cutting roller of claim 7, wherein the second end portion is the cutting portion of the blade.

13. The cutting roller of claim 7, wherein the second end portion is at least partially projecting with respect to the main body and to the insert.
